(19) United States
(12) Patent Application Publication
(10) Pub. No.: US 2026/0118210 A1
(43) Pub. Date: Apr. 30, 2026

(54) CALCULATION METHOD, DEVICE, MEDIUM, AND EQUIPMENT FOR LEAKAGE RATE OF UNDERGROUND LINED CAVERNS IN COMPRESSED AIR ENERGY STORAGE POWER STATIONS

(71) Applicant: INSTITUTE OF ROCK AND SOIL MECHANICS, CHINESE ACADEMY OF SCIENCES, WUHAN (CN)

(72) Inventors: Guanhua SUN, Wuhan (CN); Xuan GENG, WUHAN (CN); Leinian CAO, WUHAN (CN); Xianyang YU, WUHAN (CN); Jiao WANG, WUHAN (CN); Zhangxing WANG, WUHAN (CN); Kaiyuan ZHU, WUHAN (CN); Jie QU, WUHAN (CN)

(73) Assignee: INSTITUTE OF ROCK AND SOIL MECHANICS, CHINESE ACADEMY OF SCIENCES, WUHAN, HB (CN)

(21) Appl. No.: 19/367,810

(22) Filed: Oct. 23, 2025

(30) Foreign Application Priority Data
Oct. 24, 2024 (CN) 202411488327.8

(51) Int. Cl. G01M 3/32; G08B 21/18

(52) U.S. Cl. CPC G01M 3/3236; G08B 21/182

(57) ABSTRACT

The present invention discloses a method, device, medium, and equipment for calculating the leakage rate of underground lining caverns in compressed air energy storage power stations, belonging to the technical field of compressed air energy storage power stations. The method includes the following steps: obtaining the initial air mass m₀(kg) within the set time period 4 t, the theoretical air mass m₁(kg) within the set time period Δt at the end time, and the actual air mass m₂(kg) within the set time period Δt at the end time; Calculate the leakage rate of the underground lining chamber of the compressed air energy storage power station during the set time period Δt based on the initial air mass m₀(kg), the end air mass m₁(kg), and the end air mass m₂(kg) of the set time period Δt. The device, medium, and equipment can be used to implement the method. It can monitor the leakage rate of the underground lining of the compressed air energy storage power station in real time, ensuring the operational safety of the underground lining of the compressed air energy storage power station.

### TECHNICAL FIELD

The present invention relates to the technical field of compressed air energy storage power stations, particularly to a method, device, medium, and equipment for calculating the leakage rate of underground lining caverns in compressed air energy storage power stations.

### BACKGROUND TECHNOLOGY

Airtightness is one of the most critical performance indicators for underground lining caverns in compressed air energy storage, which directly affects the safety and efficiency of the energy storage system. At present, the sealing layer materials widely used in underground lining caverns are mainly divided into two categories: steel lining and polymer materials. Although polymer materials have good flexibility and corrosion resistance, they are permeable materials, so slow gas leakage may occur during long-term operation of the cavern, with a certain leakage rate. In contrast, steel lining is an impermeable material that has a good sealing effect on gases. However, during operation, due to the high pressure inside the gas storage tank, small tears or stress concentration areas may occur at the welds of the steel lining, leading to gas leakage. Although the probability of this type of leakage is low, once it occurs, it has a significant impact on the operation of the system.

Whether it is slow leakage of polymer materials or local leakage caused by weld defects in steel lining materials, these are directly related to the safety and long-term stability of the tunnel. If the leakage problem cannot be controlled in a timely and effective manner, it may lead to energy loss, reduced operational efficiency, and even pose safety hazards. Therefore, establishing a scientifically reasonable criterion for identifying and preventing potential leakage problems in the sealing layer can help identify and prevent them early, providing technical support and guarantee for the long-term stable operation of the cavern.

### SUMMARY OF THE INVENTION

In view of this, the present invention provides a method, device, medium, and equipment for calculating the leakage rate of underground lining caverns in compressed air energy storage power stations. By monitoring the process of air injection and discharge into the caverns, the ideal total stored gas volume in the caverns can be obtained. Then, by comparing the monitored actual stored gas volume with the ideal value, it can be determined whether there is a leakage in the caverns, making it more suitable for practical use.

In order to achieve the first objective mentioned above, the technical solution for calculating the leakage rate of underground lining caverns in compressed air energy storage power stations provided by the present invention is as follows:

The present invention provides a method for calculating the leakage rate of underground lining caverns in compressed air energy storage power stations, comprising the following steps:

Obtain the initial air mass m₀(kg) within the set time period Δt, where the initial air mass m₀(kg) within the set time period Δt is the theoretical total air mass inside the underground lining cavern of the compressed air energy storage power station;
Obtain the theoretical air mass m₁(kg) in the reservoir at the end time of the set time period Δt, where the theoretical air mass m₁(kg) in the reservoir at the end time of the set time period Δt is the difference between the inflation air mass and the deflation air mass in the reservoir during the set time period Δt;
Obtain the actual air quality m₂(kg) in the reservoir at the end time of the set time period Δt, where the actual air quality m₂(kg) in the reservoir at the end time of the set time period Δt is the actual monitored air quality in the reservoir;
Calculate the leakage rate of the underground lining cavern of the compressed air energy storage power station during the set time period Δt based on the initial air mass m₀(kg) in the reservoir at the set time period Δt, the theoretical air mass m₁(kg) at the end time of the set time period Δt, and the actual air mass m₂(kg) at the end time of the set time period Δt.

The method for calculating the leakage rate of underground lining caverns in compressed air energy storage power stations provided by the present invention can also be further implemented using the following technical measures.

Preferably, during the step of obtaining the theoretical air mass m₁(kg) in the chamber at the end time of the set time period Δt, the calculation formula for the theoretical air mass m₁(kg) in the chamber at the end time of the set time period Δt is:

$${m}_{1} = {m}_{0} + {\sum }_{i = 0}^{j} {v}_{i}^{1} {t}_{i}^{1} - {\sum }_{i = 0}^{k} {v}_{i}^{0} {t}_{i}^{0} \qquad ( 1 )$$

among them, m₀(kg) is the initial gas volume, which can be calculated through temperature and pressure monitoring values in the reservoir

$${t}_{i}^{1} ( s )$$

is a certain inflation time period within the Δt time period,

$${t}_{i}^{0} ( s )$$

is a certain deflation time period within the Δ t time period,

$${v}_{i}^{1} ( kg / s )$$

is the inflation flow rate within the time period of

$${t}_{i}^{1} ( s ) , {v}_{i}^{0} ( kg / s )$$

is the deflation flow rate within the time period of

$${t}_{i}^{0} ( s ) ,$$

i represents the index of different time periods, j represents that there are j inflation time periods in the Δt time period, and k represents that there are k deflation time periods in the Δt time period.

Preferably, during the step of obtaining the monitoring value m₂(kg) of the air quality in the chamber at the end time of the set time period Δt, the calculation formula for the monitoring value m₂(kg) of the air quality in the chamber at the end time of the set time period Δt is:

$${m}_{2} = ρ \times {V}_{0} \qquad ( 2 )$$

among them,

$$ρ = \frac{M}{{V}_{m}} \qquad ( 3 )$$

Among them,
V₀—Volume of underground lining cavern, m³,
M=0.02897 g/mol is molar mass of air,
Vₘ is the molar volume of a gas, obtained by solving the following equation:

$${P}_{t} = \frac{{RT}_{t}}{{V}_{m} - b} - \frac{a}{\sqrt{{T}_{t}} {V}_{m} ( {V}_{m} + b )} \qquad ( 4 )$$

in the formula, Pₜ(Pa) is the pressure of gas, R(8.314 J/(mol·K) is an ideal gas constant, Tₜ(K) is the temperature of gas, Vₘ(m³/mol) is the molar volume of gas, a and b are constants of the Ridley Kwong equation, which depend on the critical temperature and critical pressure of the gas,

$$a = \frac{0.42748 {R}^{2} {T}_{c}^{2.5}}{{P}_{c}} = 1 \text{.6052} \qquad ( 4 - a )$$

$$b = \frac{0.0 \; 8664 {RT}_{C}}{{P}_{c}} = 2.5657 \times 1 {0}^{- 5} \qquad ( 4 - b )$$

the critical temperature of air Tc≈132.5K, the critical pressure Pc≈3.77×10⁶ Paₒ

Preferably, in the step of calculating the leakage rate of the underground lining cavern of the compressed air energy storage power station during the set time period Δt based on the theoretical air mass m₁(kg) in the cavern at the end time of the set time period Δt and the air quality monitoring value m₂(kg) in the cavern at the end time of the set time period Δt, the calculation formula for the leakage rate δ of the underground lining cavern of the compressed air energy storage power station during the set time period Δt is:

$$δ = \frac{\vert {m}_{1} - {m}_{2} \vert}{{m}_{1}} \times 100 \% . \qquad ( 5 )$$

Preferably, the set time period Δt is once per hour or once per day.

In order to achieve the second objective mentioned above, the technical solution of the leakage rate calculation device for the underground lining cavern of the compressed air energy storage power station provided by the present invention is as follows:

The device for calculating the leakage rate of underground lining caverns in compressed air energy storage power stations provided by the present invention includes:

The initial air quality acquisition module in the reservoir is used to obtain the initial air quality m₀(kg) in the reservoir during a set time period Δt, where the initial air quality m₀(kg) in the reservoir during the set time period Δt is the theoretical total air mass in the underground lining cavern of the compressed air energy storage power station;

The theoretical air mass acquisition module at the end time is used to obtain the theoretical air mass m₁(kg) at the end time of the set time period Δt. The theoretical air mass m₁(kg) at the end time of the set time period Δt is the difference between the inflation air mass and the deflation air mass in the set time period Δt;

A module for obtaining the monitoring value of air quality in the warehouse at the end time, used to obtain the monitoring value m₂(kg) of air quality in the warehouse at the end time within the set time period Δt, wherein the actual air quality m₂(kg) in the warehouse at the end time within the set time period Δt is the actual monitored air quality in the warehouse;

The leakage rate calculation module is used to calculate the leakage rate of the underground lining cavern of the compressed air energy storage power station during the set time period Δt based on the initial air mass m₀(kg) in the reservoir during the set time period Δt, the theoretical air mass m₁(kg) at the end time of the set time period Δt, and the monitored air mass m₂(kg) at the end time of the set time period Δt.

The leakage rate calculation device for the underground lining cavern of the compressed air energy storage power station provided by the present invention can also be further implemented using the following technical measures.

Preferably, The device for calculating the leakage rate of the underground lining cavern of the compressed air energy storage power station further comprises,

A display device used to display basic information of the underground lining chamber of the compressed air energy storage power station, including intake and exhaust rate time history curves, pressure time history curves, temperature time history curves, leakage rate time history curves, and real-time values corresponding to each curve;

The basic information of the underground lining cavern of the compressed air energy storage power station includes burial depth, cavern diameter, volume, and pipeline diameter.

In order to achieve the third objective mentioned above, the technical solution of the computer-readable storage medium provided by the present invention is as follows:

The computer-readable storage medium provided by the present invention stores a compressed air energy storage power station underground lining cavern leakage rate calculation program, which, when executed by a processor, implements the steps of the compressed air energy storage power station underground lining cavern leakage rate calculation method provided by the present invention.

In order to achieve the fourth objective mentioned above, the technical solution of the device provided by the present invention is as follows:

The device provided by the present invention includes a pipeline monitoring system, an in warehouse monitoring system, a data interpretation module, a data display system, a memory, and a processor,

The pipeline monitoring system is used to monitor the inlet flow rate and outlet flow rate of gas pipelines;

The internal monitoring system is used to monitor the temperature, pressure, and radial expansion inside the warehouse;

The data interpretation module is used to convert the analog signals obtained by the pipeline monitoring system and the in warehouse monitoring system into digital signals;

The storage device stores a program for calculating the leakage rate of the underground lining cavern of the compressed air energy storage power station. When the program is executed by the processor, it implements the steps for calculating the leakage rate of the underground lining cavern of the compressed air energy storage power station.

The device provided by the present invention can also be further implemented using the following technical measures.

Preferably,

The intake flow rate and exhaust flow rate of the pipeline monitoring system are air flow rate sensors;

The monitoring system inside the warehouse adopts grating pressure sensors, grating temperature sensors, and grating displacement sensors, arranged inside the warehouse and pulled out by pipelines;

The average temperature inside the underground lining chamber of the compressed air energy storage power station is calculated by using temperature grating sensors installed inside the chamber, and the length or volume of each area is weighted and averaged;

The calculation of the expansion rate of the underground lining cavern of the compressed air energy storage power station adopts the inner diameter vector of the cavern to calculate the expansion size of the cavern volume.

Preferably, the alarm device is activated to trigger an alarm when the leakage rate of the underground lining chamber of the compressed air energy storage power station exceeds a safety threshold.

The present invention provides a method, device, medium, and equipment for calculating the leakage rate of underground lining caverns in compressed air energy storage power stations. The quality of gas filled in the caverns can be used as a key indicator to evaluate whether the sealing layer has leaked. Its value not only represents the total amount of gas stored in the caverns, but also reflects the energy stored in the caverns. During the operation of the cavern, when energy needs to be released for power generation, the more gas stored, the more energy can be converted. By monitoring the process of air injection and discharge from the cavern, the ideal total stored gas volume inside the cavern can be obtained. Then, by comparing the actual stored gas volume obtained from monitoring with the ideal value, it can be determined whether there is a leak in the cavern.

### BRIEF DESCRIPTION OF THE DRAWINGS

By reading the detailed description of the preferred embodiments in the following text, various other advantages and benefits will become clear to those skilled in the art. The accompanying drawings are only for the purpose of illustrating preferred embodiments and are not to be considered limiting of the present invention. And throughout the entire figure, the same reference symbols are used to represent the same components. In the attached figure:

FIG. 1 is a flowchart of the steps for calculating the leakage rate of the underground lining cavern of a compressed air energy storage power station provided in an embodiment of the present invention;

FIG. 2 is a schematic diagram of the signal flow relationship between various functional modules in the leakage rate calculation device for the underground lining cavern of a compressed air energy storage power station provided in an embodiment of the present invention;

FIG. 3 is a schematic diagram of the structure of the leakage rate calculation device for the underground lining cavern of the compressed air energy storage power station in the hardware operating environment provided by the embodiment of the present invention;

FIG. 4 is a schematic diagram of the functions and layout of an electronic device provided in an embodiment of the present invention;

Annotations on the accompanying drawings:
1. Real time display of intake or exhaust rate, 2. Real time display of internal pressure, 3. Real time display of internal temperature, 4. Real time display of leakage rate.

### EMBODIMENT

The present invention provides a method, device, medium, and equipment for calculating the leakage rate of underground lining caverns in compressed air energy storage power plants. By monitoring the process of air injection and discharge into the caverns, the ideal total stored gas volume in the caverns can be obtained. By comparing the monitored actual stored gas volume with the ideal value, it is possible to determine whether there is a leakage in the caverns, making it more suitable for practical use.

In order to further illustrate the technical means and effects adopted by the present invention to achieve the predetermined invention objectives, the following, in conjunction with the accompanying drawings and preferred embodiments, provide a detailed description of the method, device, medium, and equipment for calculating the leakage rate of underground lining caverns in compressed air energy storage power stations proposed according to the present invention, including their specific implementation methods, structures, features, and effects. In the following explanation, different “embodiments” or “embodiments” do not necessarily refer to the same embodiment. In addition, the features, structures, or characteristics in one or more embodiments may be combined in any suitable form.

The term “and/or” in this article is only a description of the association relationship between related objects, indicating that there can be three types of relationships, such as A and/or B. The specific understanding is that it can contain both A and B, can exist alone as A, or can exist alone as B, and can have any of the above three situations.

Calculation method for leakage rate of underground lining cavern in compressed air energy storage power station

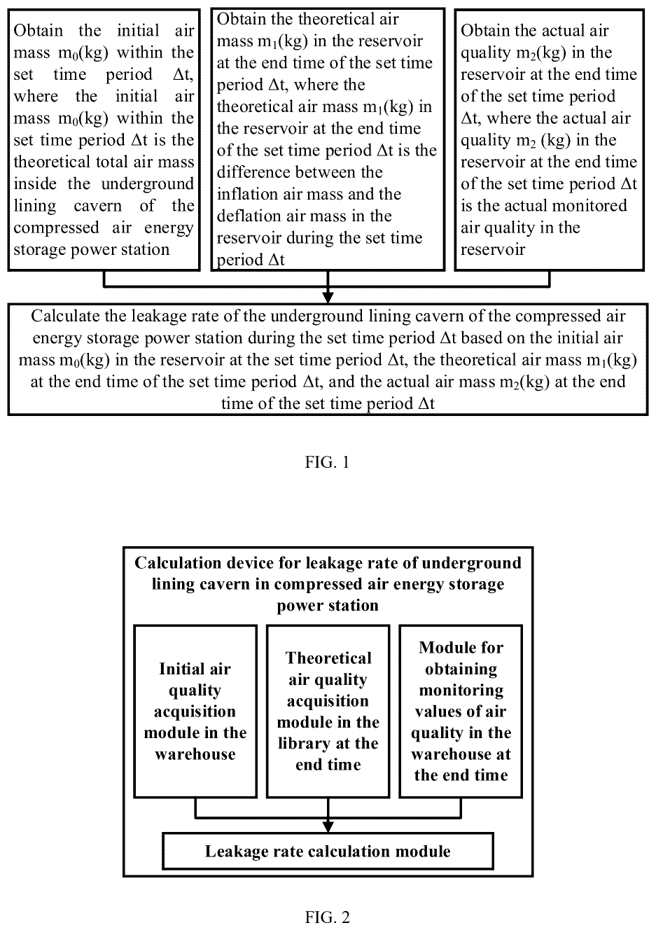

As shown in FIG. 1, the method for calculating the leakage rate of the underground lining chamber of a compressed air energy storage power station provided by the embodiment of the present invention includes the following steps:
Step 1: obtain the initial air mass m₀(kg) within the set time period Δt, where the initial air mass m₀(kg) within the set time period Δt is the theoretical total air mass inside the underground lining cavern of the compressed air energy storage power station;
Step 2: obtain the theoretical air mass m₁(kg) in the reservoir at the end time of the set time period Δt, where the theoretical air mass m₁(kg) in the reservoir at the end time of the set time period Δt is the difference between the inflation air mass and the deflation air mass in the reservoir during the set time period Δt;
Step 3: obtain the actual air quality m₂(kg) in the reservoir at the end time of the set time period Δt, where the actual air quality m₂(kg) in the reservoir at the end time of the set time period Δt is the actual monitored air quality in the reservoir;
Step 4: calculate the leakage rate of the underground lining cavern of the compressed air energy storage power station during the set time period Δt based on the initial air mass m₀(kg) in the reservoir at the set time period Δt, the theoretical air mass m₁(kg) at the end time of the set time period Δt, and the actual air mass m₂(kg) at the end time of the set time period Δt.

The embodiments of the present invention provide a method for calculating the leakage rate of underground lining caverns in compressed air energy storage power stations. The quality of gas filled in the caverns can be used as a key indicator to evaluate whether the sealing layer has leaked. Its value not only represents the total amount of gas stored in the caverns, but also reflects the energy stored in the caverns. During the operation of the cavern, when energy needs to be released for power generation, the more gas stored, the more energy can be converted. By monitoring the process of air injection and discharge from the cavern, the ideal total stored gas volume inside the cavern can be obtained. Then, by comparing the actual stored gas volume obtained from monitoring with the ideal value, it can be determined whether there is a leak in the cavern.

Wherein, during the step of obtaining the theoretical air mass m₁(kg) in the chamber at the end time of the set time period Δt, the calculation formula for the theoretical air mass m₁(kg) in the chamber at the end time of the set time period Δt is:

$${m}_{1} = {m}_{0} + {\sum }_{i = 0}^{j} {v}_{i}^{1} {t}_{i}^{1} - {\sum }_{i = 0}^{k} {v}_{i}^{0} {t}_{i}^{0} \qquad ( 1 )$$

among them, m₀(kg) is the initial gas volume, which can be calculated through temperature and pressure monitoring values in the reservoir.

$${t}_{i}^{1} ( s )$$

is a certain inflation time period within the Δt time period,

$${t}_{i}^{0} ( s )$$

is a certain deflation time period within the Δ t time period,

$${v}_{i}^{1} ( kg / s )$$

is the inflation flow rate within the time period of

$${t}_{i}^{1} ( s ) , {v}_{i}^{0} ( kg / s )$$

is the deflation flow rate within the time period of

$${t}_{i}^{0} ( s ) ,$$

i represents the index of different time periods, j represents that there are j inflation time periods in the Δt time period, and k represents that there are k deflation time periods in the Δt time period.

Wherein, during the step of obtaining the monitoring value m₂(kg) of the air quality in the chamber at the end time of the set time period Δt, the calculation formula for the monitoring value m₂(kg) of the air quality in the chamber at the end time of the set time period Δt is:

$${m}_{2} = ρ \times {V}_{0} \qquad ( 2 )$$

among them,

$$ρ = \frac{M}{{V}_{m}} \qquad ( 3 )$$

Among them,
V₀—Volume of underground lining cavern, m³,
M=0.02897 g/mol is molar mass of air,
Vₘ is the molar volume of a gas, obtained by solving the following equation:

$${P}_{t} = \frac{{RT}_{t}}{{V}_{m} - b} - \frac{a}{\sqrt{{T}_{t}} {V}_{m} ( {V}_{m} + b )} \qquad ( 4 )$$

in the formula, Pₜ(Pa) is the pressure of gas, R(8.314 J/(mol·K) is an ideal gas constant, Tₜ(K) is the temperature of gas, Vₘ(m³/mol) is the molar volume of gas, a and b are constants of the Ridley Kwong equation, which depend on the critical temperature and critical pressure of the gas,

$$a = \frac{0.42748 {R}^{2} {T}_{c}^{2.5}}{{P}_{c}} = 1 \text{.6052} \qquad ( 4 - a )$$

$$b = \frac{0.0 \; 8664 {RT}_{C}}{{P}_{c}} = 2.5657 \times 1 {0}^{- 5} \qquad ( 4 - b )$$

the critical temperature of air Tc≈132.5K, the critical pressure Pc≈3.77×10⁶ Paₒ

Preferably, in the step of calculating the leakage rate of the underground lining cavern of the compressed air energy storage power station during the set time period Δt based on the theoretical air mass m₁(kg) in the cavern at the end time of the set time period Δt and the air quality monitoring value m₂(kg) in the cavern at the end time of the set time period Δt, the calculation formula for the leakage rate δ of the underground lining cavern of the compressed air energy storage power station during the set time period Δt is:

$$δ = \frac{\vert {m}_{1} - {m}_{2} \vert}{{m}_{1}} \times 100 \% . \qquad ( 5 )$$

Preferably, the set time period Δt is once per hour or once per day.

### Calculation Device for Leakage Rate of Underground Lining Cavern in Compressed Air Energy Storage Power Station

As shown in FIG. 2, the leakage rate calculation device for the underground lining cavern of the compressed air energy storage power station provided by the embodiment of the present invention includes:

The initial air quality acquisition module in the reservoir is used to obtain the initial air quality m₀(kg) in the reservoir during a set time period Δt, where the initial air quality m₀(kg) in the reservoir during the set time period Δt is the theoretical total air mass in the underground lining cavern of the compressed air energy storage power station;

The theoretical air mass acquisition module at the end time is used to obtain the theoretical air mass m₁(kg) at the end time of the set time period Δt. The theoretical air mass m₁(kg) at the end time of the set time period Δt is the difference between the inflation air mass and the deflation air mass in the set time period Δt;

A module for obtaining the monitoring value of air quality in the warehouse at the end time, used to obtain the monitoring value m₂(kg) of air quality in the warehouse at the end time within the set time period Δt, wherein the actual air quality m₂(kg) in the warehouse at the end time within the set time period Δt is the actual monitored air quality in the warehouse;

The leakage rate calculation module is used to calculate the leakage rate of the underground lining cavern of the compressed air energy storage power station during the set time period Δt based on the initial air mass m₀(kg) in the reservoir during the set time period Δt, the theoretical air mass m₁(kg) at the end time of the set time period Δt, and the monitored air mass m₂(kg) at the end time of the set time period Δt.

The embodiments of the present invention provide a device for calculating the leakage rate of underground lining caverns in compressed air energy storage power stations. The quality of gas filled in the caverns can be used as a key indicator to evaluate whether the sealing layer has leaked. Its value not only represents the total amount of gas stored in the caverns, but also reflects the energy stored in the caverns. During the operation of the cavern, when energy needs to be released for power generation, the more gas stored, the more energy can be converted. By monitoring the process of air injection and discharge from the cavern, the ideal total stored gas volume inside the cavern can be obtained. Then, by comparing the actual stored gas volume obtained from monitoring with the ideal value, it can be determined whether there is a leak in the cavern.

Wherein, The device for calculating the leakage rate of the underground lining cavern of the compressed air energy storage power station further comprises,

A display device used to display basic information of the underground lining chamber of the compressed air energy storage power station, including intake and exhaust rate time history curves, pressure time history curves, temperature time history curves, leakage rate time history curves, and real-time values corresponding to each curve;

The basic information of the underground lining cavern of the compressed air energy storage power station includes burial depth, cavern diameter, volume, and pipeline diameter. In this case, relevant personnel can intuitively understand relevant information, data, and data trends through the display device, which can ensure the safe operation of the underground lining cavern of the compressed air energy storage power station and improve work efficiency.

### Computer Readable Storage Medium

The computer-readable storage medium provided by the present invention stores a compressed air energy storage power station underground lining cavern leakage rate calculation program. When the compressed air energy storage power station underground lining cavern leakage rate calculation program is executed by the processor, it implements the steps of the compressed air energy storage power station underground lining cavern leakage rate calculation method provided by the present invention.

The embodiments of the present invention provide a computer-readable storage medium, and the quality of the gas filled in the cavern can be used as a key indicator to evaluate whether the sealing layer leaks. Its value not only represents the total amount of gas stored in the cavern, but also reflects the energy stored in the cavern. During the operation of the cavern, when energy needs to be released for power generation, the more gas stored, the more energy can be converted. By monitoring the process of air injection and discharge from the cavern, the ideal total stored gas volume inside the cavern can be obtained. Then, by comparing the actual stored gas volume obtained from monitoring with the ideal value, it can be determined whether there is a leak in the cavern.

### Electronic Device

The device provided by the present invention includes a pipeline monitoring system, an in warehouse monitoring system, a data interpretation module, a data display system, a memory, and a processor,

The pipeline monitoring system is used to monitor the inlet flow rate and outlet flow rate of gas pipelines;

The internal monitoring system is used to monitor the temperature, pressure, and radial expansion inside the warehouse;

The data interpretation module is used to convert the analog signals obtained by the pipeline monitoring system and the in warehouse monitoring system into digital signals;

The storage device stores a program for calculating the leakage rate of the underground lining cavern of the compressed air energy storage power station. When the program is executed by the processor, it implements the steps for calculating the leakage rate of the underground lining cavern of the compressed air energy storage power station.

The present invention provides a device in which the quality of gas filled into the cavern can serve as a key indicator for evaluating whether the sealing layer has leaked. Its value not only represents the total amount of gas stored in the cavern, but also reflects the energy stored in the cavern. During the operation of the cavern, when energy needs to be released for power generation, the more gas stored, the more energy can be converted. By monitoring the process of air injection and discharge from the cavern, the ideal total stored gas volume inside the cavern can be obtained. Then, by comparing the actual stored gas volume obtained from monitoring with the ideal value, it can be determined whether there is a leak in the cavern.

Wherein, As shown in FIG. 4, The intake flow rate and exhaust flow rate of the pipeline monitoring system are air flow rate sensors; The monitoring system inside the warehouse adopts grating pressure sensors, grating temperature sensors, and grating displacement sensors, which are arranged inside the warehouse and pulled out by pipelines; The average temperature inside the underground lining chamber of the compressed air energy storage power station is calculated using temperature grating sensors installed inside the chamber, and the length or volume of each area is weighted and averaged; The expansion rate calculation of the underground lining of the compressed air energy storage power station adopts the inner diameter vector of the reservoir to calculate the expansion size of the reservoir volume. Specifically, the leakage rate monitoring system consists of the following parts: pipeline monitoring system, in warehouse monitoring system, data interpretation and storage module, data processing module, and data display system. The pipeline monitoring system mainly monitors the inlet flow rate and outlet flow rate of the gas pipeline. Using an air flow velocity sensor. The warehouse monitoring system mainly monitors the temperature, pressure, and radial expansion inside the warehouse. Using grating pressure sensors, grating temperature sensors, and grating displacement sensors, arranged in the warehouse and pulled out by pipelines. The data interpretation and storage module mainly uses servers to collect, interpret, and store data. The data processing module is mainly responsible for the following calculations: average temperature calculation, cavern expansion rate calculation, and leakage rate calculation. The average temperature inside the warehouse is calculated by using temperature grating sensors installed inside the warehouse, and the length or volume of each area is weighted and averaged. The expansion rate of the cavern is calculated using the inner diameter vector of the cavern to determine the magnitude of its volume expansion. Leakage rate calculation, using the first part calculation formula, calculates the leakage rate and calculates it once every hour, storing it in units of hours. The data display system mainly includes basic information of the cavern, intake and exhaust rate time history curves, pressure time history curves inside the cavern, temperature time history curves inside the cavern, leakage rate time history curves, and real-time numerical display of these data. The basic information of the cave includes burial depth, cave diameter, volume, pipeline diameter, etc.

Wherein, the equipment also includes an alarm device. When the leakage rate of the underground lining of the compressed air energy storage power station exceeds the safety threshold, the alarm device will be activated to achieve the alarm. In this case, through the alarm device, it is possible to obtain alarm information on the ground without anyone actually entering the underground lining of the compressed air energy storage power station. In this embodiment, the alarm information includes the precise geographical coordinates of the underground lining cavern of the compressed air energy storage power station. In this case, it can enable the staff to accurately locate the geographical location of the underground lining cavern of the compressed air energy storage power station to be repaired. In addition, the alarm device will also send maintenance instructions to the maintenance personnel closest to the underground lining cavern of the compressed air energy storage power station to be repaired based on the current location of the registered maintenance personnel. The maintenance instructions may include specific structural parameter data, composition data, and leakage data of the underground lining cavern of the compressed air energy storage power station to be repaired, so that the maintenance personnel can prepare for maintenance before actually arriving at the underground lining cavern of the compressed air energy storage power station to be repaired, such as carrying spare maintenance tools, including replacement parts and maintenance tools.

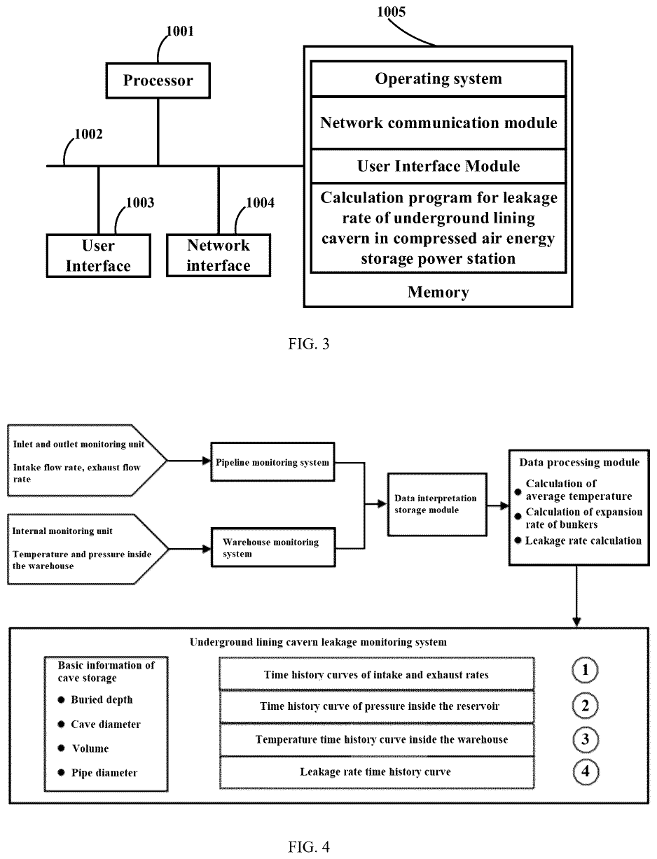

As shown in FIG. 3, FIG. 3 is a schematic diagram of the structure of the leakage rate calculation device for the underground lining cavern of the compressed air energy storage power station in the hardware operating environment according to the embodiment of the present invention.

As shown in FIG. 3, the leakage rate calculation device for the underground lining of the compressed air energy storage power station can include: processor 1001, such as a central processing unit (CPU), communication bus 1002, user interface 1003, network interface 1004, and memory 1005. Among them, the communication bus 1002 is used to achieve connection communication between these components. The user interface 1003 may include a display screen, input units such as a keyboard, and optional user interfaces 1003 may also include standard wired and wireless interfaces. The optional network interface 1004 can include standard wired interfaces and wireless interfaces (such as Wireless Fidelity (WI-FI) interfaces). Memory 1005 can be a high-speed Random Access Memory (RAM) storage or a stable Non Volatile Memory (NVM), such as a disk storage. Memory 1005 can also be an optional storage device independent of the aforementioned processor 1001.

Technicians in this field can understand that the structure shown in FIG. 3 does not constitute a limitation on the leakage rate calculation equipment of the underground lining cavern of the compressed air energy storage power station. It may include more or fewer components than shown in the diagram, or combine certain components, or arrange different components.

As shown in FIG. 3, the memory 1005 as a storage medium may include an operating system, a data storage module, a network communication module, a user interface module, and a compressed air energy storage power station underground lining cavern leakage rate calculation program.

In the leakage rate calculation device for the underground lining cavern of the compressed air energy storage power station shown in FIG. 3, the network interface 1004 is mainly used for data communication with the network server; The user interface 1003 is mainly used for data interaction with users; The processor 1001 and the memory 1005 in the leakage rate calculation device for the underground lining cavern of the compressed air energy storage power station of the present invention can be set in the leakage rate calculation device for the underground lining cavern of the compressed air energy storage power station. The leakage rate calculation device for the underground lining cavern of the compressed air energy storage power station calls the leakage rate calculation program for the underground lining cavern of the compressed air energy storage power station stored in the memory 1005 through the processor 1001, and executes the leakage rate calculation method for the underground lining cavern of the compressed air energy storage power station provided in the embodiments of the present invention.

Although preferred embodiments of the present invention have been described, those skilled in the art may make additional changes and modifications to these embodiments once they have knowledge of the basic inventive concept. Therefore, the attached claims are intended to be interpreted as including preferred embodiments and all changes and modifications falling within the scope of the present invention.

Obviously, technicians in this field can make various modifications and variations to the present invention without departing from the spirit and scope of the invention. Thus, if these modifications and variations of the present invention fall within the scope of the claims and their equivalent technologies, the present invention is also intended to include these modifications and variations.

1. A method for calculating the leakage rate of underground lining caverns in compressed air energy storage power stations, characterized by the following steps:
Obtain the initial air mass m₀(kg) within the set time period Δt, where the initial air mass m₀(kg) within the set time period Δt is the theoretical total air mass inside the underground lining cavern of the compressed air energy storage power station;
Obtain the theoretical air mass m₁(kg) in the reservoir at the end time of the set time period Δt, where the theoretical air mass m₁(kg) in the reservoir at the end time of the set time period Δt is the difference between the inflation air mass and the deflation air mass in the reservoir during the set time period Δt;
Obtain the actual air quality m₂(kg) in the reservoir at the end time of the set time period Δt, where the actual air quality m₂(kg) in the reservoir at the end time of the set time period Δt is the actual monitored air quality in the reservoir;
Calculate the leakage rate of the underground lining cavern of the compressed air energy storage power station during the set time period Δt based on the initial air mass m₀(kg) in the reservoir at the set time period Δt, the theoretical air mass m₁(kg) at the end time of the set time period Δt, and the actual air mass m₂(kg) at the end time of the set time period Δt.

2. The method for calculating the leakage rate of the underground lining chamber of a compressed air energy storage power station according to claim 1, characterized in that during the step of obtaining the theoretical air mass m₁(kg) in the chamber at the end time of the set time period Δt, the calculation formula for the theoretical air mass m₁(kg) in the chamber at the end time of the set time period Δt is:
$${m}_{1} = {m}_{0} + {\sum }_{i = 0}^{j} {v}_{i}^{1} {t}_{i}^{1} - {\sum }_{i = 0}^{k} {v}_{i}^{0} {t}_{i}^{0} \qquad ( 1 )$$
among them, m₀(kg) is the initial gas volume, which can be calculated through temperature and pressure monitoring values in the reservoir.
$${t}_{i}^{1} ( s )$$
is a certain inflation time period within the Δt time period,
$${t}_{i}^{0} ( s )$$
is a certain deflation time period within the Δ t time period,
$${v}_{i}^{1} ( kg / s )$$
is the inflation flow rate within the time period of
$${t}_{i}^{1} ( s ) , {v}_{i}^{0} ( kg / s )$$
is the deflation flow rate within the time period of
$${t}_{i}^{0} ( s ) ,$$
i represents the index of different time periods, j represents that there are j inflation time periods in the Δt time period, and k represents that there are k deflation time periods in the Δt time period.

3. The method for calculating the leakage rate of the underground lining chamber of a compressed air energy storage power station according to claim 1, characterized in that during the step of obtaining the monitoring value m₂(kg) of the air quality in the chamber at the end time of the set time period Δt, the calculation formula for the monitoring value m₂(kg) of the air quality in the chamber at the end time of the set time period Δt is:
$${m}_{2} = ρ \times {V}_{0} \qquad ( 2 )$$
among them,
$$ρ = \frac{M}{{V}_{m}} \qquad ( 3 )$$
Among them,
V₀—Volume of underground lining cavern, m³,
M=0.02897 g/mol is molar mass of air,
Vₘ is the molar volume of a gas, obtained by solving the following equation:
$${P}_{t} = \frac{{RT}_{t}}{{V}_{m} - b} - \frac{a}{\sqrt{{T}_{t}} {V}_{m} ( {V}_{m} + b )} \qquad ( 4 )$$
in the formula, Pₜ(Pa) is the pressure of gas, R(8.314 J/(mol·K) is an ideal gas constant, Tₜ(K) is the temperature of gas, Vₘ(m³/mol) is the molar volume of gas, a and b are constants of the Ridley Kwong equation, which depend on the critical temperature and critical pressure of the gas,
$$a = \frac{0.42748 {R}^{2} {T}_{c}^{2.5}}{{P}_{c}} = 1 \text{.6052} \qquad ( 4 - a )$$
$$b = \frac{0.0 \; 8664 {RT}_{C}}{{P}_{c}} = 2.5657 \times 1 {0}^{- 5} \qquad ( 4 - b )$$
the critical temperature of air Tc≈132.5K, the critical pressure Pc≈3.77×10⁶ Pa.

4. The method for calculating the leakage rate of the underground lining cavern of a compressed air energy storage power station according to claim 1, characterized in that, in the step of calculating the leakage rate of the underground lining cavern of the compressed air energy storage power station during the set time period Δt based on the theoretical air mass m₁(kg) in the cavern at the end time of the set time period Δt and the air quality monitoring value m₂(kg) in the cavern at the end time of the set time period Δt, the calculation formula for the leakage rate δ of the underground lining cavern of the compressed air energy storage power station during the set time period Δt is:
$$δ = \frac{\vert {m}_{1} - {m}_{2} \vert}{{m}_{1}} \times 100 \% . \qquad ( 5 )$$

5. The method for calculating the leakage rate of underground lining caverns in compressed air energy storage power plants according to claim 1, characterized in that the set time period Δt is once per hour or once per day.

6. A device for calculating the leakage rate of underground lining caverns in compressed air energy storage power stations, comprising:
The initial air quality acquisition module in the reservoir is used to obtain the initial air quality m₀(kg) in the reservoir during a set time period Δt, where the initial air quality m₀(kg) in the reservoir during the set time period Δt is the theoretical total air mass in the underground lining cavern of the compressed air energy storage power station;
The theoretical air mass acquisition module at the end time is used to obtain the theoretical air mass m₁(kg) at the end time of the set time period Δt. The theoretical air mass m₁(kg) at the end time of the set time period Δt is the difference between the inflation air mass and the deflation air mass in the set time period Δt;
A module for obtaining the monitoring value of air quality in the warehouse at the end time, used to obtain the monitoring value m₂(kg) of air quality in the warehouse at the end time within the set time period Δt, wherein the actual air quality m₂(kg) in the warehouse at the end time within the set time period Δt is the actual monitored air quality in the warehouse;
The leakage rate calculation module is used to calculate the leakage rate of the underground lining cavern of the compressed air energy storage power station during the set time period Δt based on the initial air mass m₀(kg) in the reservoir during the set time period Δt, the theoretical air mass m₁(kg) at the end time of the set time period Δt, and the monitored air mass m₂(kg) at the end time of the set time period Δt.

7. The device for calculating the leakage rate of underground lining caverns in compressed air energy storage power plants according to claim 6, further comprising:
A display device used to display basic information of the underground lining chamber of the compressed air energy storage power station, including intake and exhaust rate time history curves, pressure time history curves, temperature time history curves, leakage rate time history curves, and real-time values corresponding to each curve;
The basic information of the underground lining cavern of the compressed air energy storage power station includes burial depth, cavern diameter, volume, and pipeline diameter.

8. (canceled)

9. A device comprising a pipeline monitoring system, an in warehouse monitoring system, a data interpretation module, a data display system, a memory, and a processor,
The pipeline monitoring system is used to monitor the inlet flow rate and outlet flow rate of gas pipelines;
The internal monitoring system is used to monitor the temperature, pressure, and radial expansion inside the warehouse;
The data interpretation module is used to convert the analog signals obtained by the pipeline monitoring system and the in warehouse monitoring system into digital signals;
The storage device stores a program for calculating the leakage rate of the underground lining cavern of the compressed air energy storage power station. When executed by the processor, the program implements the steps of the leakage rate calculation method for the underground lining cavern of the compressed air energy storage power station as claimed in claim 1.

10. The device according to claim 9, characterized in that:
The intake flow rate and exhaust flow rate of the pipeline monitoring system are air flow rate sensors;
The monitoring system inside the warehouse adopts grating pressure sensors, grating temperature sensors, and grating displacement sensors, arranged inside the warehouse and pulled out by pipelines;
The average temperature inside the underground lining chamber of the compressed air energy storage power station is calculated by using temperature grating sensors installed inside the chamber, and the length or volume of each area is weighted and averaged;
The calculation of the expansion rate of the underground lining cavern of the compressed air energy storage power station adopts the inner diameter vector of the cavern to calculate the expansion size of the cavern volume.

11. The device according to claim 9, further comprising an alarm device, wherein the alarm device is activated to trigger an alarm when the leakage rate of the underground lining chamber of the compressed air energy storage power station exceeds a safety threshold.
